(19) United States
(12) Patent Application Publication
(10) Pub. No.: US 2026/0278190 A1
(43) Pub. Date: Sep. 17, 2026

(54) RESILIENCE-ORIENTED PRODUCT DESIGN METHOD FOR HIGH-IMPACT DISTURBANCE ABSORPTION, ADAPTATION, AND AUTONOMOUS RECOVERY

(71) Applicant: Sichuan University, Chengdu (CN)

(72) Inventors: Xin GUO, Chengdu (CN); Mingyue YANG, Chengdu (CN); Bowen XU, Chengdu (CN); Wu ZHAO, Chengdu (CN); Hao XUE, Chengdu (CN); Bo WU, Chengdu (CN); Kai ZHANG, Chengdu (CN); Jun LI, Chengdu (CN); Miao YU, Chengdu (CN)

(73) Assignee: Sichuan University, Chengdu (CN)

(21) Appl. No.: 19/328,267

(22) Filed: Sep. 15, 2025

(30) Foreign Application Priority Data
Mar. 11, 2025 (CN) 202510279302.5

(51) Int. Cl. G06F 30/13

(52) U.S. Cl. CPC G06F 30/13

(57) ABSTRACT

The provided is a resilience-oriented product design method for high-impact disturbance absorption, adaptation, and autonomous recovery. The method includes: determining functions and structures of a product based on user requirements; introducing at least one disturbance, extracting functions and structures associated with the disturbance from the functions and the structures of the product, and constructing a disturbance-structural failure-functional failure network (DSFN); determining vulnerable functions; configuring at least one resilient design factor for the vulnerable functions; combining the vulnerable functions with a selected resilient design factor to form updated functions; and based on mapping of the updated functions, updating vulnerable structures. The provided explains how the high-impact disturbance restricts the design process, minimizes the side effect of the high-impact disturbance, and improves the resilience of the product.

### CROSS-REFERENCE TO THE RELATED APPLICATIONS

This application is based upon and claims priority to Chinese Patent Application No. 202510279302.5, filed on Mar. 11, 2025, the entire contents of which are incorporated herein by reference.

### TECHNICAL FIELD

The present disclosure belongs to the technical field of product design, and relates to a resilience-oriented product design method for high-impact disturbance absorption, adaptation, and autonomous recovery.

### BACKGROUND

With advanced information technologies and artificial intelligence (AI) technologies, products can realize different functions more efficiently to meet diversified requirements of users. However, due to an increasingly large number of structures and a complex coupling relationship between components, products are more vulnerable to high-impact disturbances and prone to disruptions. For example, events such as the great blackout in the United States in 2004, the earthquakes in the Haiti, Chile and Japan in 2012, the worldwide COVID-19 in 2019, and the regional conflicts in recent years have seriously disrupted the normal production and life of human beings as well as the normal operation of products, causing severe economic losses and safety consequences. Hence, it is necessary to take corresponding measures to improve abilities of the products to resist the high-impact disturbances, and to solve the structural and functional failures, thus prolonging the service life of the products.

In order to cope with the failures and high-impact disturbances, many researchers mainly focus on reinforcement, optimization and maintenance of the structures to develop products with high reliability. Meanwhile, as a new paradigm, resilience endows products with absorption, adaptation, recovery, and learning, providing a new design concept to cope with the high-impact disturbance.

According to patents CN 202011577019.4, CN 201380047741.9, CN 201911077243.4 and the like, preventive maintenance for coping with the high-impact disturbances mainly focus on equipment failure diagnosis and maintenance plan generation. The former performs feature extraction and model training on operation data and information of the product with a machine learning algorithm to generate a maintenance prediction model for the product. The latter generates a most optimal and reliable maintenance plan under constraints of limited resources and costs. Such maintenance methods as corrective maintenance and preventive maintenance can recover the product from the failures, but are not cost-effective and are time-consuming, or even delay the progress of work.

The patent CN 202410285433.X provides an earthquake-proof resilient design method for a medical building. Through resilient objective determination, structural safety design, earthquake-proof resilient design, post-earthquake function verification of the building, quick recovery of functions, and the like, structural safety of the building is ensured to meet predetermined functions. However, this patent focuses more on improving reliability of the medical building through reinforcement and optimization of the structures, but less on quick recovery strategies of the functions. Moreover, with the increase of natural disasters and the continuous rise of external and internal threats, a product designed with high reliability is still prone to failures when exceeding a safety threshold under high-impact and unpredictable disturbances.

### SUMMARY

In view of the above problems in the prior art, the present disclosure provides a resilience-oriented product design method for high-impact disturbance absorption, adaptation, and autonomous recovery, to solve a resilient product design scheme under a high-impact disturbance and such constraints as an evaluation object, and help the designer develop a resilient product design. While improving an ability of the product to cope with the high-impact disturbance, the present disclosure meets user requirements, and ensures that product attributes fluctuate in an acceptable range, providing supports for subsequent manufacturing, use, operation and maintenance of the resilient product.

With consideration to influences of the high-impact disturbance on the product and its design process, the present disclosure identifies functional and structural failures in combination with historical data. The present disclosure can help the designer better understand causes of the failure, and take measures for the high-impact disturbance or failure, improving the ability of the product to cope with the high-impact disturbance. Meanwhile, the present disclosure also takes into account the user satisfaction and the product attribute. Otherwise, it will lead to unnecessary cost increase, impair the interests of the user, or even affect implementation of the final scheme. Therefore, how to conduct failure analysis, take measures to improve resilience of the product, and seek a balance between the user satisfaction and the product attribute has become a core problem of the present disclosure to construct the resilient product design.

Based on the above analysis, the present disclosure provides a resilience-oriented product design method for high-impact disturbance absorption, adaptation, and autonomous recovery, including following steps:
S1: determining functions and structures of a product based on user requirements;
S2: introducing at least one disturbance, extracting functions and structures associated with the disturbance from the functions and the structures of the product, and constructing a disturbance-structural failure-functional failure network (DSFN);
S3: based on the constructed DSFN, determining vulnerable functions, thereby dividing the functions of the product into normal functions and the vulnerable functions; configuring at least one resilient design factor for the vulnerable functions; and combining the vulnerable functions with a selected resilient design factor to form updated functions;
S4: based on the constructed DSFN and the vulnerable functions, dividing the structures of the product into normal structures and vulnerable structures; and based on mapping of the updated functions, updating the vulnerable structures; and
S5: combining the normal structures with updated structures to obtain a plurality of resilient product design schemes.

In the step S1, a plurality of functions of the product are determined based on the user requirements. The functions each represent an action of one structure on another structure.

Hence, according to each function, a corresponding structure meeting the function can be determined. This operation is also mapping from a functional domain to a structural domain, thereby constructing a function-structure model. In the function-structure model, an edge between two structures represents an action between the two structures, namely a function associated with the two structures. Conventional methods disclosed in the art can be used to construct the function-structure model based on the user requirements, including ((1) a functional analysis method, Dong, Y, Tan, R., Zhang, P., Peng, Q., & Shao, P. (2021), Product Redesign Using Functional Backtrack with Digital Twin, Advanced Engineering Informatics, 49, 101361; and (2) a function-behavior-structure mapping method, Gero JS (1990) Design Prototypes: A Knowledge Representation Schema for Design, AI Magazine 11(4): 26-36).

In the step S2, by introducing the disturbance (particularly a high-impact disturbance) to the function-structure model, the structures are damaged, such that influenced functional failures can be identified quickly. In view of this, the DSFN can be constructed. The DSFN includes a disturbance layer, a structural failure layer, and a functional failure layer; the disturbance layer includes the introduced at least one disturbance; the structural failure layer includes the structures associated with the disturbance (namely mechanisms influenced by the disturbance); and the functional failure layer includes functions associated with the structures of the structural failure layer.

The step S3 includes: based on the constructed DSFN, calculating failure priority indexes (FPIs), and acquiring rankings of functional failures of the product; and based on the rankings of the functional failures of the product, selecting a plurality of failed functions as the vulnerable functions.

Based on the step S3, the functions of the product are represented as:

$$F = \{ {F}_{i} \} ⋃ \{ {F}_{xy}^{r} \} ,$$

where, Fᵢ represents the normal functions, i=1, 2, . . . , n, and n being a number of the normal functions, and F_{xy}^{r} represents the updated functions after the resilient design factor is introduced, x=1, 2, . . . , j, j being a number of the vulnerable functions, and y∈absorption, adaptation, learning, recovery, and service.

In the step S4, based on the constructed DSFN and the vulnerable functions, dividing the structures of the product into the normal structures and the vulnerable structures specifically includes:

$$S = \{ {S}_{{i}^{′}} \} ⋃ \{ {S}_{{x}^{′}} \} ,$$

where, s_{i′} represents the normal structures, i′=1,2, . . . , m and m being a number of the normal structures; and s_{x′} represents the vulnerable structures, x′=1,2, . . . , j′ and j′ being a number of the vulnerable structures.

Based on the mapping of the updated functions, the vulnerable structures are updated by:

$$\{ {S}_{{x}^{′} y}^{r} \} = [ DM ] ⋆ \{ {F}_{xy}^{r} \} ,$$

$$and$$

$$[ DM ] = [ \begin{matrix}{a}_{11} & … & {a}_{1 n} \\ … & … & … \\ {a}_{m 1} & … & {a}_{mm}\end{matrix} ] ,$$

where, [DM] represents a design matrix; {S_{x′y}^{r}} represents an updated structure set for the vulnerable structures; {F_{xy}^{y}} represents an updated function set; and aₘₙ represents a mapping relationship between S_{x′y}^{r} and F_{xy}^{r}, the corresponding aₘₙ=1 when the mapping relationship exists, otherwise aₘₙ=0.

In the step S5, the resilient product design schemes are represented as:

$${S}^{N e w} = \{ {S}_{{i}^{′}} \} ⋃ \{ {S}_{{x}^{′} y}^{r} \} ,$$

where, s^{New} represents the resilient product design schemes.

The resilience-oriented product design method for high-impact disturbance absorption, adaptation, and autonomous recovery further includes:
S6: constructing objective functions and constraints for a cost, a carbon emission, and a weight in the resilient product design scheme, and solving constructed objective functions to obtain a candidate resilient design scheme.

Herein, considerations are mainly given to the cost, the carbon emission, and the weight generated by each of the updated structures, and the objective functions are as follows:

$$\{ \begin{matrix}min C = {\sum }_{k = 1}^{K} {\sum }_{l = 1}^{L} {ε}_{kl} ( cos {t}_{kl}^{R a w} + cos {t}_{kl}^{D e s i g n} + cos {t}_{kl}^{Manufacturing} + cos {t}_{kl}^{S e r v i c e} ) \\ \begin{matrix}min E = {\sum }_{k = 1}^{K} {\sum }_{l = 1}^{L} {ε}_{kl} ( {CFP}_{kl}^{R a w} + {CFP}_{kl}^{D i s t r i b u t i o n} + \\ {CFP}_{kl}^{Manufacturing} + {CFP}_{kl}^{U s e} + {CFP}_{kl}^{Eol} )\end{matrix} \\ min W = {\sum }_{k = 1}^{K} {\sum }_{l = 1}^{L} {ε}_{kl} ( {V}_{kl} ⋆ {ρ}_{kl} )\end{matrix}$$

where, εₖₗ represents a weight of an lth structure of a kth function;

$$cos {t}_{k l}^{R a w}$$

represents a raw material cost of the lth structure of the kth function;

$$cos {t}_{kl}^{Design}$$

represents a design cost of the lth structure of the kth function;

$$cos {t}_{kl}^{Manufacturing}$$

represents a manufacturing cost of the lth structure of the kth function;

$$cos {t}_{kl}^{Service}$$

represents a service cost of the lth structure of the kth function;

$${CFP}_{k l}^{R a w}$$

a represents a carbon emission generated in acquisition of raw material of the lth structure of the kth function;

$${CFP}_{k l}^{Distribution}$$

represents a carbon emission generated in distribution of the lth structure of the kth function;

$${CFP}_{k l}^{Manufacturing}$$

represents a carbon emission generated in manufacturing of the lth structure of the kth function;

$${CFP}_{k l}^{Use}$$

represents a carbon emission generated in use of the lth structure of the kth function;

$${CFP}_{k l}^{E o l}$$

represents a carbon emission generated at an end of life (EOL) of the lth structure of the kth function; vₖₗ represents a volume of the lth structure of the kth function; ρₖₗ represents a density of the lth structure of the kth function; and K and L respectively represent a number of functions and a number of structures under corresponding functions; and
the constraints are as follows:

$$\{ \begin{matrix}C ⋆ ( 1 + α ) \leq {C}_{max} \\ E \leq {E}_{max} \\ W \leq {W}_{max} \\ {\sum }_{k = 1}^{K} {ε}_{k l} = 1 , for l = 1 , 2 , 3 , … L\end{matrix} ,$$

where, Cₘₐₓ, Eₘₐₓ and Wₘₐₓ respectively represent a maximum cost, a maximum carbon emission, and a maximum weight; and a represents an extra cost coefficient, including unconsidered factors such as an operation factor, a supply chain management factor, and an environmental factor.

In a preferred implementation, the objective functions for the cost, the carbon emission, and the weight are solved with a non-dominated sorting genetic algorithm II (NSGA-II) to obtain a Pareto solution set for the candidate resilient product design scheme.

Compared with the prior art, the present disclosure has the following beneficial effects:
(1) By considering influences of the high-impact disturbance on the product and enhancing influences of the resilience on the user requirements and product attributes, the resilience-oriented product design method for high-impact disturbance absorption, adaptation, and autonomous recovery provided by the present disclosure explains how the high-impact disturbance restricts the design process, minimizes the side effect of the high-impact disturbance, and improves the resilience of the product.
(2) During the design process, the present disclosure improves the ability of the product to cope with the high-impact disturbance from five aspects, including absorption, adaptation, recovery, learning, and service. With functional backtrack, the present disclosure establishes a mapping relationship between the structural failure and the functional failure as well as a mapping relationship between the functional adjustment and the structural adjustment under the high-impact disturbance.
(3) The present disclosure proposes key steps such as a preventive failure analysis method and scheme configuration incorporating the resilient design factor, to solve the optimal resilient design scheme under the high-impact disturbance, while taking into account the user satisfaction and product attributes.
(4) The present disclosure takes the complex hole-forming equipment as a case, and verifies effectiveness of the proposed design method with the preventive failure analysis method and the scheme configuration incorporating the resilient design factor, laying a foundation for digitalization and intellectualization of the product design.

### BRIEF DESCRIPTION OF THE DRAWINGS

The following describes the accompanying drawings of the specification in details.

FIG. 1 is a schematic diagram of a design principle of a resilient product based on functional backtrace;

FIG. 2 is a schematic flowchart of a resilience-oriented product design method for high-impact disturbance absorption, adaptation, and autonomous recovery according to an embodiment of the present disclosure;

FIG. 3 illustrates a conceptual design of hole-forming equipment;

FIGS. 4A-4B illustrate a disturbance-function-structure model (FIG. 4A) and a DSFN (FIG. 4B) of a product according to an embodiment of the present disclosure;

FIG. 5 illustrates a Bayesian network;

FIG. 6 illustrates a disturbance-function-structure model of hole-forming equipment according to an embodiment of the present disclosure;

FIG. 7 illustrates a topological structure of a DSFN of hole-forming equipment based on a Bayesian network according to an embodiment of the present disclosure;

FIG. 8 illustrates updated structures mapped upon functional adjustment according to an embodiment of the present disclosure;

FIG. 9 illustrates a candidate resilient design scheme of hole-forming equipment according to an embodiment of the present disclosure; and

FIG. 10 illustrates a candidate resilient design scheme of a valve stem according to an embodiment of the present disclosure.

### DETAILED DESCRIPTION OF THE EMBODIMENTS

The technical solutions in the embodiments of the present disclosure are clearly and completely described below with reference to the drawings. Apparently, the described embodiments are merely some rather than all of the embodiments of the present disclosure. All other embodiments obtained by a person of ordinary skill in the art based on the embodiments of the present disclosure without creative efforts should fall within the protection scope of the present disclosure.

In order to verify effectiveness of the method in the present disclosure, the embodiment takes a resilient design process of hole-forming equipment as a case. The hole-forming equipment is industrial complex equipment that converts gravitational potential energy into kinetic energy to crush rocks, and has been widely applied to construction of such power transmission infrastructures as towers and utility poles. With advancements in ultra-high-voltage (UHV) power transmission technologies, higher requirements are imposed on supporting micro-pile holes. Since field environments and underground environments are complex and unpredictable, and hardness of the rock is increased with a diameter and a depth of the rock, a failure risk of drilling equipment is aggravated by various high-impact disturbances. Hence, resilient drilling rigs have been designed. This not only ensures the hole-forming efficiency and quality but also improves the ability of the hole-forming equipment to cope with external disturbances.

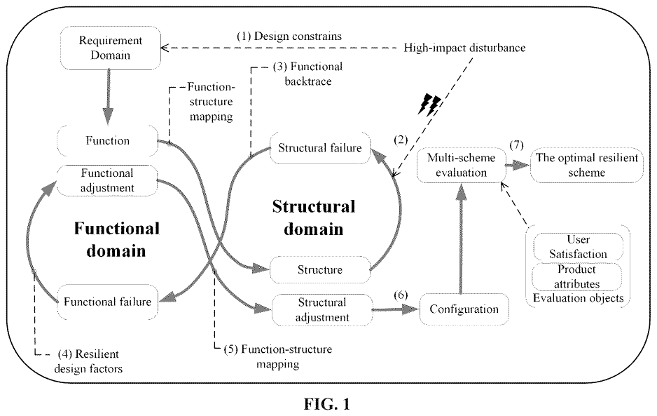

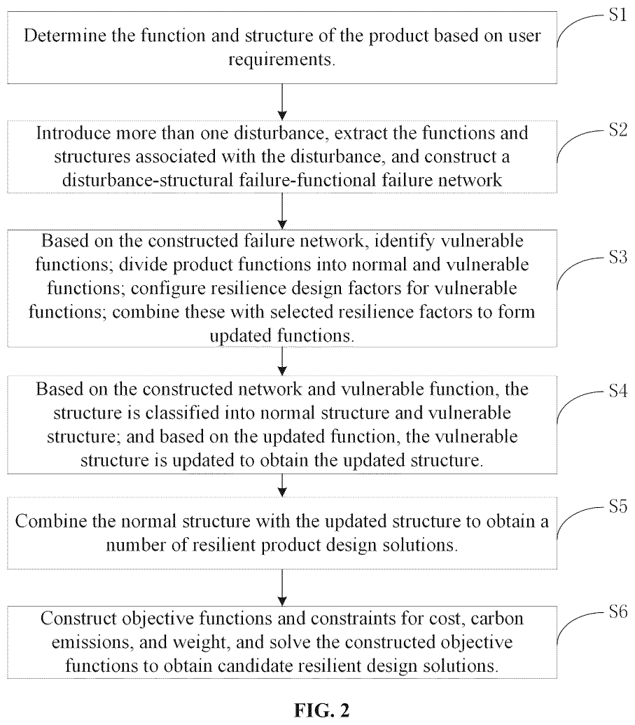

As shown in FIG. 1 and FIG. 2, the embodiment provides a resilience-oriented product design method for high-impact disturbance absorption, adaptation, and autonomous recovery, including following steps:

S1: Functions and structures of a product are determined based on user requirements.

A plurality of functions of the product are determined based on the user requirements. The functions each represent an action of one structure on another structure, and are expressed by Eq. (1). That is, structure a acts on structure b through action Aᵢ.

$${A}_{i} : Structure a \to Structure b . \qquad ( 1 )$$

Hence, according to each function, a corresponding structure meeting the function can be determined. This operation is also mapping from a functional domain to a structural domain, thereby constructing a function-structure model. In the function-structure model, an edge between two structures represents an action between the two structures, namely a function associated with the two structures. Conventional methods disclosed in the art can be used to construct the function-structure model based on the user requirements, including (1) a functional analysis method, Dong, Y, Tan, R., Zhang, P., Peng, Q., & Shao, P. (2021), Product Redesign Using Functional Backtrack with Digital Twin, Advanced Engineering Informatics, 49, 101361; and (2) a function-behavior-structure mapping method, Gero JS (1990) Design Prototypes: A Knowledge Representation Schema for Design, AI Magazine 11(4): 26-36).

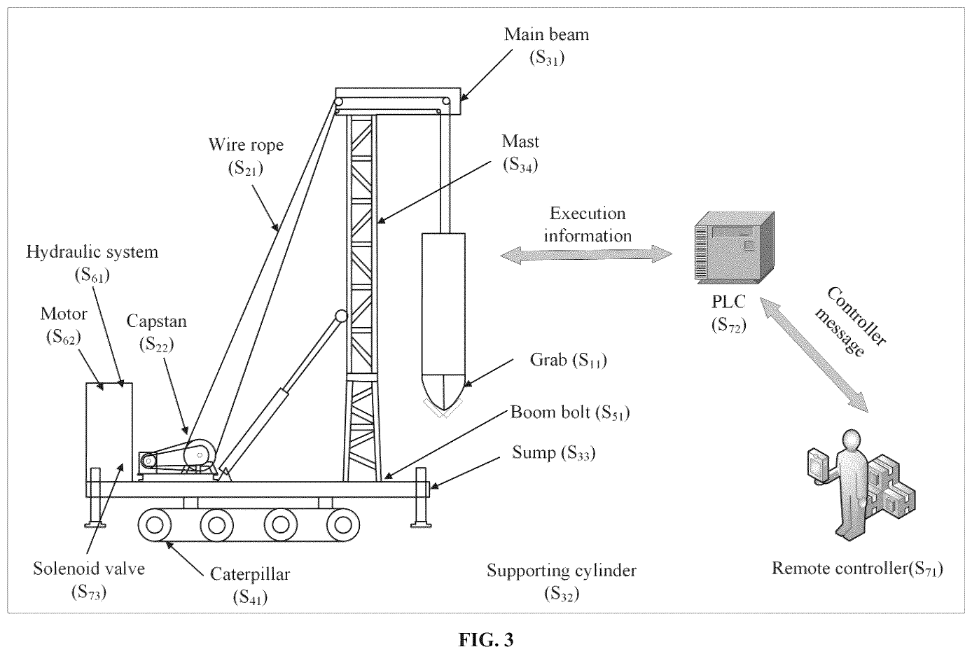

In the embodiment, based on early user requirement analysis and function-structure mapping, functions and structures of the hole-forming equipment are determined, including digging, traction, supporting, walking, retaining, driving, and control. Corresponding structures meeting design requirements are selected as follows: a grab, a wire rope, a capstan, a main beam, a supporting cylinder, a sump, a mast, a caterpillar, a boom bolt, a hydraulic system, a motor, a remote controller, a programmable logic controller (PLC), and a solenoid valve, as shown in FIG. 3.

S2: At least one disturbance is introduced, functions and structures associated with the disturbance are extracted from the functions and the structures of the product, and a DSFN is constructed.

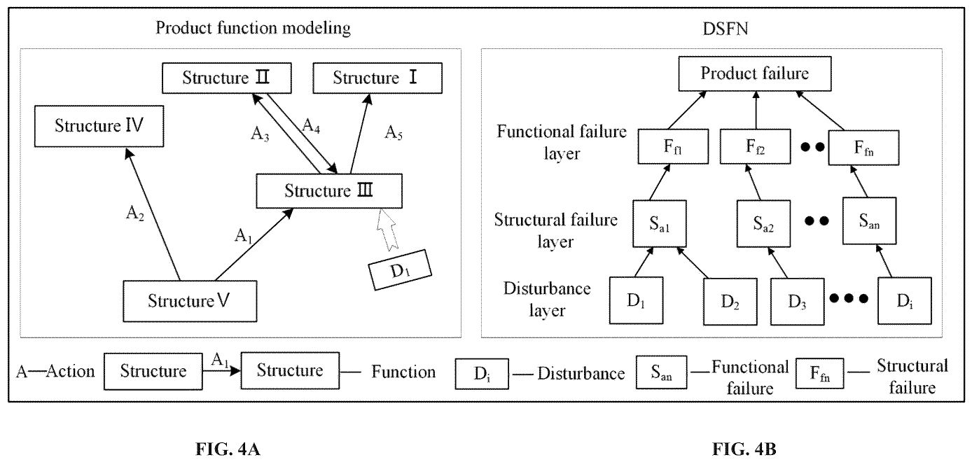

By introducing a high-impact disturbance (Dᵢ) to the function-structure model, the structures are damaged, such that influenced function failures can be identified quickly, as shown in FIGS. 4A-4B. For example, D₁ causes a failure to structure III, such that functions A₁, A₂, A₃, and A₅ realized by structures I, II, and V associated with the structure III are influenced, as shown in Eq. (2), where a represents a failure factor, and A represents an influencing factor.

$${D}_{i} {\to }^{\partial } structure i {\to }^{λ} ( {A}_{1} , {A}_{2} , … , {A}_{i} ) . \qquad ( 2 )$$

The disturbance, influenced structures and influenced functions in the functional model are extracted to construct the DSFN. Hence, the DSFN includes a disturbance layer, a structural failure layer, and a functional failure layer. The disturbance layer includes the introduced at least one disturbance, and it represents different disturbances D₁, D₂, . . . , Dᵢ arising from an external environment, a human factor, and a product internal factor. The structural failure layer includes the structures associated with the disturbance (namely mechanisms influenced by the disturbance). Under the high-impact disturbance, performance deteriorations or structural failures of the product are labeled as Sₐ₁, Sₐ₂, . . . , Sₐₙ. The functional failure layer includes functions associated with the structures of the structural failure layer. On the functional failure layer, the product under the influence of the structural failures cannot perform expected functions, labeled as F_{f1}, F_{f2}, . . . , F_{fn}. A directed edge represents a failure causal relationship between three layers.

In the embodiment, for the above hole-forming equipment, three types of high-impact disturbances, namely hard rock, dirt, gravel, and uneven surface, and alternating load from cyclical digging, are considered. In response to digging to the hard rock, such as granite, grab teeth may suffer wearing or even breakage. Cyclical digging to the ground causes cyclical load change of the drilling rig, leading to wearing and breakage of the wire rope, deformation and breakage of the mast, looseness and breakage of the boom bolt, etc. Walking on the dirt, gravel, and uneven surface may cause wearing and breakage of the caterpillar. The above structural failures will influence execution of corresponding functions, causing functional failures.

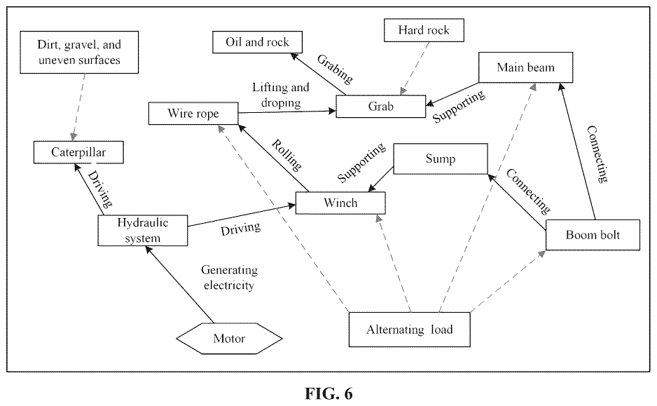

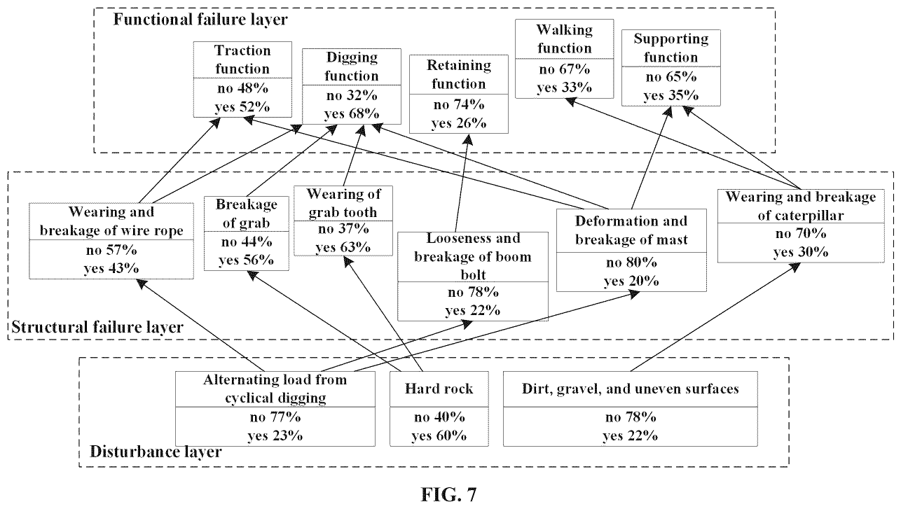

The above high-impact disturbances, structural failures and functional failures are used to construct the disturbance-function model and the DSFN, as shown in FIG. 6 and FIG. 7. In FIG. 7, ‘ yes’ represents a probability of occurrence, and ‘ no’ represents a probability of non-occurrence. Specifically, the probability is calculated based on statistical data corresponding to failures in actual operation of the grab or estimated based on expert's experience. Given a probability of occurrence for an underlying node and a probability of occurrence for an upper-level node under occurrence conditions of the underlying node, a probability of occurrence for the upper-level node can be solved with the total probability rule.

S3: Based on the constructed DSFN, vulnerable functions are determined, thereby dividing the functions of the product into normal functions and the vulnerable functions, at least one resilient design factor is configured for the vulnerable functions, and the vulnerable functions are combined with a selected resilient design factor to form updated functions.

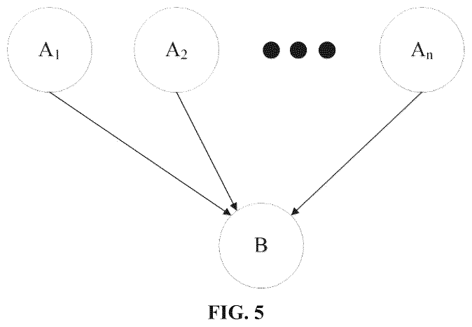

For a topological structure of the DSFN, an FPI is used to evaluate the functional failures from multiple dimensions, such as a severity (S), a probability of occurrence (P) and a detectivity (D). In subsequent design, these vulnerable functions are considered preferentially, as shown in Eq. (3). The probability of occurrence refers to a failure frequency in the reliability and service life of the product. It is solved by a Bayesian network, and represents a conditional probability, such as a failure probability of structure B under high-impact disturbance A, and a failure probability of function C in failure of the structure B. Taking FIG. 5 for example, to calculate the failure probability P(B) of the structure B, probability P(Aₙ) of occurrence for each parent node (high-impact disturbance) Aₙ is multiplied by failure probability P(B|Aₙ) of the structure B under occurrence conditions of each parent node Aₙ based on the total probability rule, namely Eq. (4). To solve a posterior probability, namely the probability P(Aₙ|B) of occurrence for the event Aₙ in the failure of the structure B, as shown in Eq. (5), only the P(B|Aₙ) and the P(Aₙ) are solved. The P(B|Aₙ) and the P(Aₙ) can be obtained by recording a number of historical product failure times. The severity (S) describes a degree of the structural failure and influences of the structural failure on other structures of the product. The detectivity (D) describes a possibility that the failure can be detected. The severity and the detectivity are assigned by the expert based on experience and concern extent on the indicator.

$$FPI = S \times P \times D ; \qquad ( 3 )$$

$$P ( B ) = P ( {A}_{1} ) P ( B \vert {A}_{1} ) + P ( {A}_{2} ) P ( B \vert {A}_{2} ) + … + P ( {A}_{n} ) P ( B \vert {A}_{n} ) ; and \qquad ( 4 )$$

$$P ( {A}_{1} \vert B ) = \frac{P ( B \vert {A}_{1} ) P ( {A}_{1} )}{P ( B )} = \frac{P ( B \vert {A}_{1} ) P ( {A}_{1} )}{{\sum }_{i = 1}^{n} P ( B \vert {A}_{i} ) P ( {A}_{i} )} . \qquad ( 5 )$$

Rankings of functional failures of the product are acquired based on calculated FPIs. Based on the rankings of the functional failures of the product, a plurality of failed functions are selected as the vulnerable functions.

In the embodiment, the probability of occurrence for the functional failure is calculated with a Bayes' theorem. Failure probabilities of the “digging function”, the “supporting function”, the “traction function”, the “retaining function”, and the “walking function” can be calculated as 0.68, 0.35, 0.52, 0.33, and 0.26. The expert gives scores for severities and detectivities of different functional failures, FPI values according to Eq. (3), and rankings of the FPI values. Compared with other failures, more attention is required for risks of the digging function and the traction function of the drilling rig, as shown in Table 1. Therefore, the functions of the product are divided into normal functions Fᵢ and vulnerable functions Fₓ.

TABLE 1
Rankings of functional failures of the drilling rig

| Functional failure | S | D | P | FPI | Ranking |
|---|---|---|---|---|---|
| Traction function | 8 | 4 | 0.52 | 16.64 | 2 |
| Walking function | 6 | 8 | 0.33 | 15.84 | 4 |
| Digging function | 8 | 6 | 0.68 | 32.64 | 1 |
| Supporting function | 6 | 8 | 0.35 | 16.8 | 3 |
| Retaining function | 4 | 8 | 0.26 | 8.32 | 5 |

For the vulnerable functions Fₓ solved by the DSFN, five resilient design factors y, including absorption, adaptation, recovery, learning, and service, are defined for functional adjustment. The functions of the product are represented as Eq. (6). Fᵢ represents the normal functions. The selected resilient design factor is combined with the vulnerable functions to obtain the updated functions F_{xy}^{r} after the resilient design factor is introduced, thereby enhancing abilities of these vulnerable functions to cope with the high-impact disturbance.

$$F = \{ {F}_{i} \} ⋃ \{ {F}_{xy}^{r} \} , \qquad ( 6 )$$

where, Fᵢ represents the normal functions, i=1, 2, . . . , n, and n being a number of the normal functions, and F_{xy}^{r} represents the updated functions after the resilient design factor is introduced, x=1, 2, . . . , j, j being a number of the vulnerable functions, and y∈absorption, adaptation, learning, recovery, and service.

In order to cope with the functional failure, five resilient design factors, namely absorption, adaptation, recovery, learning, and service, are defined. The resilient design factors are combined with the vulnerable functions to obtain the updated functions. The resilient design factors are specifically defined as follows:
The absorption refers to an inherent ability of the product to withstand and weaken continuous influences of the high-impact disturbances on performance, and minimize consequences of the disturbances. The product can be prepared in advance, and corresponding adjustments can be made through reinforcement on weak links of the product, product upgrade, regular maintenance and other means. Meanwhile, enhancing independence between the structures can minimize cascading failures and set corresponding buffers to keep them within a critical threshold.

The adaptation reflects an ability of the product to identify the high-impact disturbances, predict potential failures, continue operation in the event of a disruption, and optimize recovery plans based on the discovery of the disruption event, especially when the absorption ability is exceeded. Specifically, it can be realized in the following ways: (1) monitoring a state and an external environment of the product through a sensor; (2) predicting weaknesses, a remaining service life and possible failures of the product based on monitoring performance data; (3) allocating an authority of a task priority at emergency time; (4) flexibly changing a configuration of the product; and (5) enhancing a coordination or control ability of the product. The sensor and the communication algorithm are used to enhance interaction between components.

The recovery refers to an ability of the product to restore to an acceptable state. This state meets operational requirements through structural and functional redundancy. The structural redundancy refers to the use of pre-designed backup structures, namely redundant resources, to replace damaged structures. The functional redundancy is to restore the target component to a desired state by training structures with similar functions.

The learning describes an ability of learning from previous high-impact disturbances through collection and analysis of events, crises and accidents as well as deep learning, so as to improve the process, reconfigure structures and recover actions, making preparations for future known and possible similar disturbances, and further accelerating the response to the high-impact disturbances or failures. The learning ability can be improved from the following aspects: (1) Active learning and passive learning: The active learning means monitoring execution of work of the product and learning from a gap between imagined work in the design stage and actual work. Passive learning refers to learning from changes and failures that have already occurred. (2) Data sharing: In addition to historical data and experience, failure data between products can be transferred across organizational boundaries. For example, if one product experiences a structural failure in a severe weather, another product learns from failure data of this product and accordingly adjusts its structures and functions to cope with such a high-impact interference. (3) Product adjustment: Iteratively test and reconfiguration are performed based on a learning result to recover the scheme.

Due to technical limitations, it is difficult for the product to independently cope with all high-impact disturbances. The role of the service becomes prominent mainly in three aspects: (1) Providing resources required by the product: During the process of handling failures, resources of the product, such as a redundancy and a power, are consumed, and these resources are replenished by people. (2) Providing maintenance services: Preventive maintenance (predicting failures based on monitoring data and providing corresponding measures) is conducted to keep the system healthy and prevent the failures. In addition, corrective maintenance is conducted to restore the functions of a failed component or subsystem. (3) Strategic decision-making: When the product is disturbed, strategies can be quickly adopted with limited resources to restore the failed product.

S4: Based on the constructed DSFN and the vulnerable functions, the structures of the product are divided into normal structures and vulnerable structures; and based on mapping of the updated functions, the vulnerable structures are updated.

Based on the DSFN, the structures (S) of the product can be divided into the normal structures (Sᵢ′) and the vulnerable structures (Sᵢ′). New functions are remapped to the structural domain to adjust the vulnerable structures. The new functions define an updated function set {F_{xy}^{r}}. Improved structures also define an updated structure set {S_{x′y}^{r}} for vulnerable structures. A mapping relationship between two sets is represented with a design matrix [DM] by Eqs. (7) to (9):

$$S = \{ {S}_{{i}^{′}} \} ⋃ \{ {S}_{{x}^{′}} \} , \qquad ( 7 )$$

where, s_{i′} represents the normal structures, i′=1, 2, . . . , m and m being a number of the normal structures; and s_{x′} represents the vulnerable structures, x′=1, 2, . . . , j′ and j′ being a number of the vulnerable structures.

$$\{ {S}_{{x}^{′} y}^{r} \} = [ DM ] * \{ {F}_{xy}^{r} \} ; and \qquad ( 8 )$$

$$[ DM ] = [ \begin{matrix}{a}_{11} & … & {a}_{1 n} \\ … & … & … \\ {a}_{m 1} & … & {a}_{mn}\end{matrix} ] , \qquad ( 9 )$$

where, [DM] represents the design matrix; {S_{x′y}^{r}} represents an updated structure set for the vulnerable structures; {F_{xy}^{r}} represents an updated function set; and aₘₙ represents a mapping relationship between S_{x′y}^{r} and F_{xy}^{r}, the corresponding aₘₙ=1 when the mapping relationship exists, otherwise aₘₙ=0.

For example, concerning the grab (corresponding to the digging function) of the hole-forming equipment, the design matrix between updated functions and updated structures on the digging is as follows:

| | | Digging | Digging | Digging | Digging | Digging |
|---|---|---|---|---|---|---|
| | | function | function | function | function | function |
| | Digging | with | with | with | with | with |
| | function | absorption | adaptation | recovery | learning | service |
| S₁ grab | 1 | 0 | 0 | 0 | 0 | 0 |
| S₁₁ grab made of | 0 | 1 | 0 | 0 | 0 | 0 |
| tungsten carbide | | | | | | |
| S₁₂ triaxial inclination | 0 | 0 | 1 | 0 | 0 | 0 |
| and tension sensor | | | | | | |
| S₁₃ redundant grab arm | 0 | 0 | 0 | 1 | 0 | 0 |
| S₁₄ triple grab arm | 0 | 0 | 0 | 1 | 0 | 0 |
| S₁₅ learning module | 0 | 0 | 0 | 0 | 1 | 0 |
| S₁₆ manual replacement | 0 | 0 | 0 | 0 | 0 | 1 |
| of failed grab arm | | | | | | |
| S₁₇ preventive maintenance | 0 | 0 | 0 | 0 | 0 | 1 |

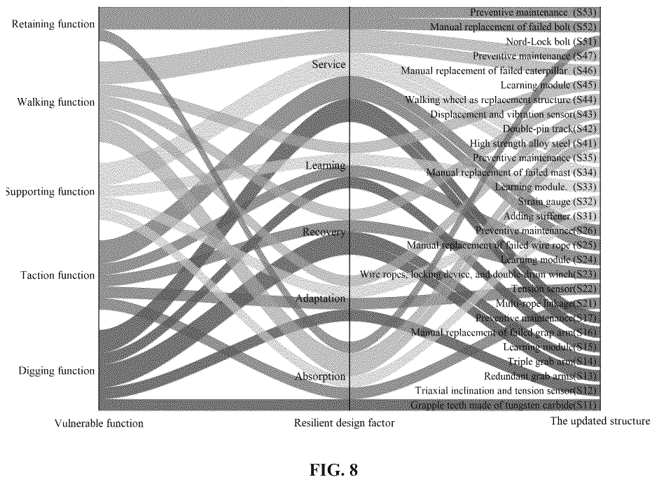

In the embodiment, for the design of the hole-forming equipment, resilient design factors are configured for vulnerable functions, new function formed upon functional adjustment are further mapped back to the structural domain, and vulnerable structures are adjusted to obtain improved new structures, as shown in FIG. 8.

S5: The normal structures are combined with the updated structures to obtain a plurality of resilient product design schemes.

The resilient product design schemes are represented as:

$${S}^{New} = \{ {S}_{{i}^{′}} \} ⋃ \{ {S}_{{x}^{′} y}^{r} \} , \qquad ( 10 )$$

where, S^{New} represents the resilient product design scheme.

In the embodiment, in the design of the hole-forming equipment, for the same functional failure, the formed new structures are combined randomly to form updated structures. The normal structures are combined with the updated structures to form resilient product design schemes for use in subsequent scheme configuration.

S6: Objective functions and constraints for a cost, a carbon emission, and a weight in the resilient product design scheme are constructed, and constructed objective functions are solved to obtain a candidate resilient design scheme.

Obtained structure sets are combined to configure different resilient design schemes. During configuration, whether the cost, environment, and product attributes are influenced is to be considered. In the present disclosure, the cost, weight, and carbon emission are introduced to serve as constraints for configuring the resilient design scheme, and they represent requirements on budgeting, lightweighting, and environmental factors of the product. With the NSGA-II for solving, a trade-off scheme in which the carbon emission, the cost and the weight of the product are minimized is obtained.

Herein, considerations are mainly given to the cost, the carbon emission, and the weight generated by each of the updated structures, and the objective functions are as follows:

$$\{ \begin{matrix}min C = {\sum }_{k = 1}^{K} {\sum }_{l = 1}^{L} {ε}_{kl} ( \begin{matrix}cos {t}_{kl}^{Raw} + cos {t}_{kl}^{Design} + \\ cos {t}_{kl}^{Manufacturing} + cos {t}_{kl}^{Service}\end{matrix} ) \\ min E = {\sum }_{k = 1}^{K} {\sum }_{l = 1}^{L} {ε}_{kl} ( \begin{matrix}{CFP}_{kl}^{Raw} + {CFP}_{kl}^{Distribution} + \\ {CFP}_{kl}^{Manufacturing} + {CFP}_{kl}^{Use} + {CFP}_{kl}^{Eol}\end{matrix} ) \\ min W = {\sum }_{k = 1}^{K} {\sum }_{l = 1}^{L} {ε}_{kl} ( {V}_{kl} * {ρ}_{kl} ) ,\end{matrix} , \qquad ( 11 )$$

where, εₖₗ represents a weight of an lth structure of a kth function;

$$cos {t}_{kl}^{Raw}$$

represents a raw material cost of the lth structure of the kth function;

$$cos {t}_{kl}^{Design}$$

represents a design cost of the lth structure of the kth function;

$$cos {t}_{kl}^{Manufacturing}$$

represents a manufacturing cost of the lth structure of the kth function;

$$cos {t}_{kl}^{Service}$$

represents a service cost of the lth structure of the kth function;

$${CFP}_{kl}^{Raw}$$

represents a carbon emission generated in acquisition of raw material of the lth structure of the kth function;

$${CFP}_{kl}^{Distribution}$$

represents a carbon emission generated in distribution of the lth structure of the kth function;

$${CFP}_{kl}^{Manufacturing}$$

represents a carbon emission generated in manufacturing of the lth structure of the kth function;

$${CFP}_{kl}^{Use}$$

represents a carbon emissions generated in use of the lth structure of the kth function;

$${CFP}_{kl}^{Eol}$$

represents a carbon emission generated at an EOL of the lth structure of the kth function; vₖₗ represents a volume of the lth structure of the kth function; ρₖₗ represents a density of the lth structure of the kth function; and K and L respectively represent a number of functions and a number of structures under corresponding function.

The constraints are as follows:

$$\{ \begin{matrix}C * ( 1 + α ) \leq {C}_{max} \\ E \leq {E}_{max} \\ W \leq {W}_{max} \\ {\sum }_{k = 1}^{K} {ε}_{kl} = 1 , for l = 1 , 2 , 3 , … L\end{matrix} , \qquad ( 12 )$$

where, Cₘₐₓ, Eₘₐₓ and Wₘₐₓ respectively represent a maximum cost, a maximum carbon emission, and a maximum weight; and a represents an extra cost coefficient, including unconsidered factors such as an operation factor, a supply chain management factor, and an environmental factor.

Expenditures associated with raw material purchasing, design, manufacturing and service are mainly considered in terms of the cost. The weight refers to a cumulative weight of a structure after all components are assembled. The carbon emission mainly refers to a carbon footprint for measuring the whole EOL of the product, including five different stages: raw material purchasing, manufacturing, assembly, distribution, use and EOL. Concerning the constraints, each optimal objective should not exceed a certain value. Only one structural variant (corresponding to a last term in Eq. (12)) can be selected for each type of structures. At last, through non-dominated sorting and a calculated crowding degree of the NSGA-II, a Pareto solution set of the candidate resilient design scheme is obtained.

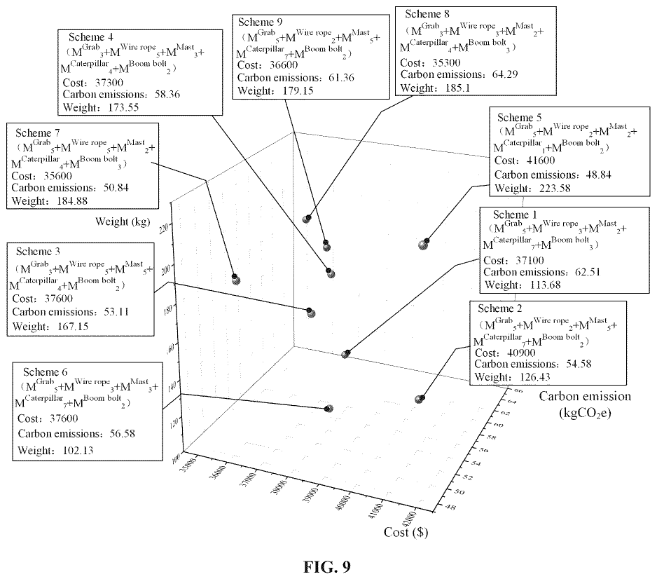

In the embodiment, the cost, the carbon emission, and the weight of each updated structure are calculated, as shown in Table 2. A mathematical model is established based on Eqs. (11)-(12), and an NSGA-II optimization algorithm is used for calculation. The candidate resilient design scheme is obtained at last, as shown in FIG. 9.

TABLE 2
Updated structures of the hole-forming equipment

| Update | | | Carbon emission/ | |
|---|---|---|---|---|
| structure | Example | Cost/$ | Kg CO₂e | Weight/Kg |
| M^{grab} | M^{grab}₁(S₁₁ [symbol] + S₁₂ [symbol] + S₁₃ [symbol] ) | 19000.00 | 55.02 | 124.25 |
| | M^{grab}₂(S₁₁ [symbol] + S₁₂ [symbol] + S₁₄ [symbol] ) | 13500.00 | 36.02 | 75.75 |
| | M^{grab}₃(S₁₂ [symbol] + S₁₄ [symbol] + S₁₅ [symbol] ) | 10700.00 | 25.93 | 50.97 |
| | M^{grab}₄(S₁₂ [symbol] + S₁₃ [symbol] + S₁₇ [symbol] ) | 15000.00 | 31.48 | 99.25 |
| | M^{grab}₅(S₁₂ [symbol] + S₁₄ [symbol] + S₁₇ [symbol] ) | 9500.00 | 12.48 | 50.75 |
| | M^{grab}₆(S₁₂ [symbol] + S₁₅ [symbol] + S₁₃ [symbol] ) | 16200.00 | 44.93 | 99.47 |
| | M^{grab}₇(S₁₁ [symbol] + S₁₆ [symbol] + S₁₇ [symbol] ) | 20000.00 | 53.79 | 124.00 |
| | M^{grab}₈(S₁₂ [symbol] + S₁₄ [symbol] + S₁₅ [symbol] + S₁₇ [symbol] ) | 12700.00 | 25.93 | 50.97 |
| | M^{grab}₉(S₁₁ [symbol] + S₁₂ [symbol] + S₁₆ [symbol] ) | 21000.00 | 55.02 | 124.25 |
| | M^{grab}₁₀(S₁₁ [symbol] + S₁₄ [symbol] + S₁₆ [symbol] ) | 22500.00 | 65.04 | 174.50 |
| M^{wire rope} | M^{wire rope}₁ (S₂₁ [symbol] + S₂₂ [symbol] + S₂₃ [symbol] ) | 16500.00 | 44.70 | 86.40 |
| | M^{wire rope}₂ (S₂₁ [symbol] + S₂₂ [symbol] + S₂₄ [symbol] + S₂₅ [symbol] ) | 13500.00 | 8.84 | 61.90 |
| | M^{wire rope}₃ (S₂₁ [symbol] + S₂₂ [symbol] + S₂₄ [symbol] + S₂₆ [symbol] ) | 10500.00 | 5.59 | 31.20 |
| | M^{wire rope}₄ (S₂₂ [symbol] + S₂₄ [symbol] + S₂₃ [symbol] ) | 20000.00 | 42.57 | 55.95 |
| | M^{wire rope}₅ (S₂₂ [symbol] + S₂₄ [symbol] + S₂₅ [symbol] ) | 12000.00 | 5.59 | 31.20 |
| | M^{wire rope}₆ (S₂₂ [symbol] + S₂₃ [symbol] ) | 15000.00 | 41.45 | 55.70 |
| | M^{wire rope}₇ (S₂₂ [symbol] + S₂₃ [symbol] + S₂₅ [symbol] ) | 19000.00 | 44.70 | 86.40 |
| M^{mast} | M^{mast}₁(S₃₁ [symbol] + S₃₃ [symbol] ) | 24200.00 | 50.46 | 71.92 |
| | M^{mast}₂(S₃₁ [symbol] + S₃₂ [symbol] + S₃₄ [symbol] ) | 5300.00 | 6.80 | 7.05 |
| | M^{mast}₃(S₃₁ [symbol] + S₃₂ [symbol] + S₃₅ [symbol] ) | 6300.00 | 9.12 | 7.50 |
| | M^{mast}₄(S₃₂ [symbol] + S₃₅ [symbol] + S₃₃ [symbol] ) | 26100.00 | 49.08 | 66.62 |
| | M^{mast}₅(S₃₂ [symbol] + S₃₅ [symbol] + S₃₄ [symbol] ) | 6600.00 | 3.87 | 1.10 |
| | M^{mast}₆(S₃₂ [symbol] + S₃₄ [symbol] + S₃₃ [symbol] ) | 26000.00 | 75.72 | 230.88 |
| M^{caterpillar} | M^{caterpillar}₁(S₄₁ [symbol] + S₄₃ [symbol] + S₄₆ [symbol] ) | 13000.00 | 18.47 | 100.88 |
| | M^{caterpillar}₂(S₄₁ [symbol] + S₄₂ [symbol] ) | 30000.00 | 75.48 | 250.00 |
| | M^{caterpillar}₃(S₄₃ [symbol] + S₄₂ [symbol] + S₄₆ [symbol] ) | 23000.00 | 63.49 | 150.88 |
| | M^{caterpillar}₄(S₄₃ [symbol] + S₄₄ [symbol] + S₄₆ [symbol] ) | 8000.00 | 15.47 | 80.88 |
| | M^{caterpillar}₅(S₄₁ [symbol] + S₄₂ [symbol] + S₄₆ [symbol] ) | 32000.00 | 75.48 | 250.00 |
| | M^{caterpillar}₆(S₄₄ [symbol] + S₄₃ [symbol] + S₄₅ [symbol] ) | 10000.00 | 35.81 | 89.13 |
| | M^{caterpillar}₇(S₄₃ [symbol] + S₄₅ [symbol] + S₄₆ [symbol] + S₄₇ [symbol] ) | 11000.00 | 27.14 | 9.68 |
| M^{bolt} | M^{bolt}₁(S₃₁ [symbol] + S₅₂ [symbol] ) | 700.00 | 10.50 | 15.00 |
| | M^{bolt}₂(S₅₃ [symbol] + S₅₂ [symbol] ) | 300.00 | 2.25 | 3.00 |
| | M^{bolt}₃(S₅₃ [symbol] + S₅₁ [symbol] + S₅₂ [symbol] ) | 800.00 | 10.50 | 15.00 |

[symbol]

indicates data missing or illegible when filed

Compared with other alternatives, the scheme 1 (namely the structure set M^{grab}₅+M^{wire rope}₃+M^{mast}₂+M^{caterpillar}₇+M^{bolt}₃ in Table 2) outperforms other solutions at a lower cost and a lower weight. By executing functions in this scheme, the user requirements are met, and the resilience of the product is enhanced. For all functional failures, preventive maintenance is performed in the scheme 1, such that structural failures can be predicted in advance and corresponding measures are taken, minimizing economic burdens of the user. For a failure in the digging function, the triaxial inclination and tension sensor detects breakage of the grab arm, and controls the central drive motor to retract the broken grab arm, and remaining three grab arms to continue to finish the work. For a failure in the traction function, under a same cyclic load, the multi-rope linkage is used to replace the single wire rope, so as to reduce wearing. The tension sensor is configured to detect whether the wire rope breaks, discover an abnormal tension timely by learning tension data, and predict possible breakage time of the wire rope through a learning module. For damage in the supporting function, a stiffener is used to reinforce an ability of the mast to resist periodic overturning moment, and a strain gauge is used to monitor whether the mast breaks. For a failure in the walking function of the caterpillar, a displacement and vibration sensor and a learning module are used to monitor and predict whether the caterpillar is worn or damaged. If the caterpillar is damaged, a damaged portion of the caterpillar is replaced manually due to complexity of the caterpillar. For a failure in the retaining function, the Nord-lock bolt is used to absorb a cyclic load, preventing looseness of the boom bolt. The damaged boom bolt is replaced manually. To sum up, the scheme 1 can improve the resilience of the product, while meeting the user requirements within acceptable ranges of the cost, the carbon emission and the weight, as shown in FIG. 9.

The resilience-oriented product design method for high-impact disturbance absorption, adaptation, and autonomous recovery provided by the present disclosure is described below with design of another equipment.

As a clean and efficient new energy resource, shale gas features a high pressure, a high output and the like, and has become an important means for the natural gas industry to increase reserves and production. Shale gas wells mainly focus on “pressure releasing and output releasing”. Fine pressure-controlled production implemented through a regulating valve is considered as an important means to maintain stratum energy, maximize a predicted exploitable reserve (EUR) of the single well, and realize long-term stable production of the gas well. As a core component in shale gas exploitation, the fine pressure-controlled regulating valve is advantageous for high temperature resistance, high pressure resistance, erosion resistance, high control accuracy, etc. However, in view of deformation, wearing, breakage and other failure problems of key components (such as a valve stem) in mounting and use, it is essential to design the resilient pressure-controlled regulating valve, so as to quickly recover the regulating valve in the failure to an accurate pressure-controlled normal state.

For example, when the failed structure is the valve stem, through the resilience-oriented product design method for high-impact disturbance absorption, adaptation, and autonomous recovery provided by the present disclosure, “power transfer and motion control” is determined as a failed function. The selected resilient design factor is combined with the failed function to obtain an updated function, namely “power transfer and motion control with recoverability”. Then, based on mapping of the updated function, the failed structure that is the valve stem is updated. The following schemes are provided for the updated structure:

Scheme 1: A resilient valve stem structure is provided for the valve stem. A specific composition of the resilient valve stem structure is disclosed in the patent CN202510436093.0. Upon breakage of the valve stem, the resilient valve stem structure is triggered to continuously transfer a regulation acting force instead of the broken valve stem to realize self-repairing for a regulating function of the valve.

Scheme 2: A resilient rod segment fitted to the valve stem is designed. The resilient rod segment includes a rod segment body, as well as a first rod cylinder and a second rod cylinder that are coaxially connected through a first flexible structure. A specific composition of the resilient rod segment is disclosed in the patent 202411844968.2. Upon breakage of the rod segment body, the first rod cylinder and the second rod cylinder connected to the first flexible structure can transfer a power instead of the rod segment body, so as to automatically recover a function of the resilient rod segment to realize self-repairing of the valve stem.

Scheme 3: A self-sensing mechanism for valve stem breakage, a redundant valve stem, and a secondary valve are designed. Specific compositions of the self-sensing mechanism for valve stem breakage, the redundant valve stem, and the secondary valve are disclosed in the patent CN 202510162460.2. In case of the breakage of the valve stem, the self-sensing mechanism for valve stem breakage automatically identifies the breakage failure of the valve stem at prompt response and high reliability. The redundant valve stem is used to replace the main valve stem to automatically recover a function of the valve stem. The designed secondary valve may further be used for overcurrent control before self-repairing of the valve stem.

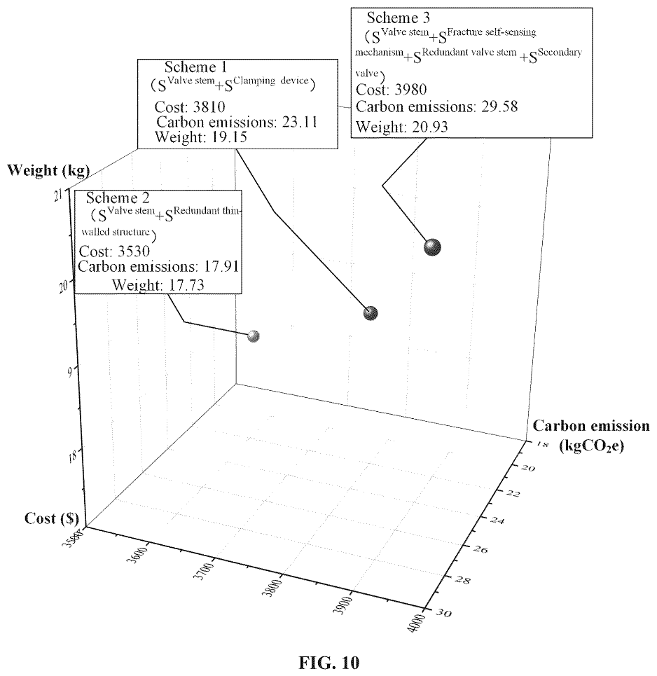

In various schemes for the updated structure of the valve stem, the cost, the carbon emission and the weight are as shown in FIG. 10. Through calculation, compared with other candidate schemes, while meeting the autonomous recovery requirement upon the breakage of the valve stem, the scheme 2 outperforms the scheme 1 and the scheme 3 in terms of the cost, the carbon emission, and the weight, weakening negative effects of the improved resilience on other attributes of the product. Therefore, the scheme 2 is an optimal solution under various indicators.

Those of ordinary skill in the art will understand that the embodiments described herein are intended to help readers understand the principles of the present disclosure, and it should be understood that the protection scope of the present disclosure is not limited to such special statements and embodiments. Those of ordinary skill in the art may make other various specific modifications and combinations according to the technical teachings disclosed in the present disclosure without departing from the essence of the present disclosure, and such modifications and combinations still fall within the protection scope of the present disclosure.

What is claimed is:

1. A resilience-oriented product design method for high-impact disturbance absorption, adaptation, and autonomous recovery, comprising following steps:
S1: determining functions and structures of a product based on user requirements;
S2: introducing at least one disturbance, extracting functions and structures associated with the at least one disturbance from the functions and the structures of the product, and constructing a disturbance-structural failure-functional failure network (DSFN);
S3: based on the DSFN, determining vulnerable functions, wherein the functions of the product are divided into normal functions and the vulnerable functions; configuring at least one resilient design factor for the vulnerable functions; and combining the vulnerable functions with a selected resilient design factor to form updated functions;
S4: based on the DSFN and the vulnerable functions, dividing the structures of the product into normal structures and vulnerable structures; and based on mapping of the updated functions, updating the vulnerable structures to obtain updated structures; and
S5: combining the normal structures with the updated structures to obtain a plurality of resilient product design schemes.

2. The resilience-oriented product design method for the high-impact disturbance absorption, adaptation, and autonomous recovery according to claim 1, wherein in the step S2, the DSFN comprises a disturbance layer, a structural failure layer, and a functional failure layer; the disturbance layer comprises the at least one disturbance; the structural failure layer comprises the structures associated with the at least one disturbance; and the functional failure layer comprises functions associated with the structures of the structural failure layer.

3. The resilience-oriented product design method for the high-impact disturbance absorption, adaptation, and autonomous recovery according to claim 1, wherein the step S3 comprises: based on the DSFN, calculating failure priority indexes (FPIs), and acquiring rankings of functional failures of the product; and based on the rankings of the functional failures of the product, selecting a plurality of failed functions as the vulnerable functions.

4. The resilience-oriented product design method for the high-impact disturbance absorption, adaptation, and autonomous recovery according to claim 3, wherein based on the step S3, the functions of the product are represented as:
$$F = \{ {F}_{i} \} ⋃ \{ {F}_{xy}^{r} \} ,$$
wherein Fᵢ represents the normal functions, i=1, 2, . . . , n, and n being a number of the normal functions, and F_{xy}^{r} represents the updated functions after the resilient design factor is introduced, x=1, 2, . . . , j, j being a number of the vulnerable functions, and y E absorption, adaptation, learning, recovery, and service.

5. The resilience-oriented product design method for the high-impact disturbance absorption, adaptation, and autonomous recovery according to claim 4, wherein in the step S4, based on the DSFN and the vulnerable functions, dividing the structures of the product into the normal structures and the vulnerable structures comprises:
$$S = \{ {S}_{{i}^{′}} \} ⋃ \{ {S}_{{x}^{′}} \} ,$$
wherein S_{i′} represents the normal structures, i′=1, 2, . . . , m and m being a number of the normal structures; and S_{x′} represents the vulnerable structures, x′=1, 2, . . . , j′ and j′ being a number of the vulnerable structures.

6. The resilience-oriented product design method for the high-impact disturbance absorption, adaptation, and autonomous recovery according to claim 5, wherein based on the mapping of the updated functions, the vulnerable structures are updated by:
$$\{ {S}_{{x}^{′} y}^{r} \} = [ DM ] * \{ {F}_{xy}^{r} \} , and$$
$$[ DM ] = [ \begin{matrix}{a}_{11} & … & {a}_{1 n} \\ … & … & … \\ {a}_{m 1} & … & {a}_{mn}\end{matrix} ] ,$$
wherein [DM] represents a design matrix; {S_{x′y}^{r}} represents an updated structure set for the vulnerable structures; {F_{xy}^{r}} represents an updated function set; and aₘₙ represents a mapping relationship between S_{x′y}^{r} and F_{xy}^{r}, aₘₙ=1 when the mapping relationship exists, and aₘn=0 when the mapping relationship does not exist.

7. The resilience-oriented product design method for the high-impact disturbance absorption, adaptation, and autonomous recovery according to claim 6, wherein in the step S5, the plurality of resilient product design schemes are represented as:
$${S}^{N e w} = \{ {S}_{{i}^{′}} \} ⋃ \{ {S}_{{x}^{′} y}^{r} \} ,$$
wherein S^{New} represents the plurality of resilient product design schemes.

8. The resilience-oriented product design method for the high-impact disturbance absorption, adaptation, and autonomous recovery according to claim 1, further comprising:
S6: constructing objective functions and constraints for a cost, a carbon emission, and a weight in the resilient product design scheme, and solving the objective functions to obtain a candidate resilient design scheme.

9. The resilience-oriented product design method for the high-impact disturbance absorption, adaptation, and autonomous recovery according to claim 8, wherein the objective functions for the cost, the carbon emission, and the weight in the resilient product design scheme are constructed as follows:
$$\{ \begin{matrix}\begin{matrix}minC = {\sum }_{k = 1}^{K} {\sum }_{l = 1}^{L} {ε}_{kl} ( cos {t}_{kl}^{R a w} + cos {t}_{kl}^{D e s i g n} + \\ cos {t}_{kl}^{M a n u f a c t u r i n g} + cos {t}_{kl}^{S e r v i c e} )\end{matrix} \\ \begin{matrix}min E = {\sum }_{k = 1}^{K} {\sum }_{l = 1}^{L} {ε}_{kl} ( C F {P}_{kl}^{R a w} + C F {P}_{kl}^{Del} + \\ {CFP}_{kl}^{M a n u f a c t u r i n g} + C F {P}_{kl}^{U s e} + C F {P}_{kl}^{Eol} )\end{matrix} \\ min W = {\sum }_{k = 1}^{K} {\sum }_{l = 1}^{L} {ε}_{kl} ( {V}_{kl} * {ρ}_{kl} )\end{matrix} ,$$
wherein εₖₗ represents a weight of an lth structure of a kth function;
$$cos {t}_{k l}^{R a w}$$
represents a raw material cost of the lth structure of the kth function;
$$cos {t}_{kl}^{Design}$$
represents a design cost of the lth structure of the kth function;
$$cos {t}_{kl}^{Manufacturing}$$
represents a manufacturing cost of the lth structure of the kth function;
$$cos {t}_{kl}^{Service}$$
represents a service cost of the lth structure of the kth function;
$$C F {P}_{k l}^{R a w}$$
represents a carbon emission generated in acquisition of raw material of the lth structure of the kth function;
$$C F {P}_{k l}^{D e l}$$
represents a carbon emission generated in distribution of the lth structure of the kth function;
$$C F {P}_{k l}^{Manufacturing}$$
represents a carbon emission generated in manufacturing of the lth structure of the kth function;
$$C F {P}_{k l}^{U s e}$$
represents a carbon emission generated in use of the lth structure of the kth function;
$$C F {P}_{k l}^{E o l}$$
represents a carbon emission generated at an end of life (EOL) of the lth structure of the kth function; Vₖₗ represents a volume of the lth structure of the kth function; ρₖₗ represents a density of the lth structure of the kth function; and K and L respectively represent a number of functions and a number of structures under corresponding functions; and
the constraints are as follows:
$$\{ \begin{matrix}C * ( 1 + α ) \leq {C}_{m ax} \\ E \leq {E}_{m ax} \\ W \leq {W}_{m ax} \\ {\sum }_{k = 1}^{K} {ε}_{kl} = 1 , for 1 = 1 , 2 , 3 , … L\end{matrix} ,$$
wherein Cₘₐₓ, Eₘₐₓ and Wₘₐₓ respectively represent a maximum cost, a maximum carbon emission, and a maximum weight; and a represents an extra cost coefficient.

10. The resilience-oriented product design method for the high-impact disturbance absorption, adaptation, and autonomous recovery according to claim 9, wherein the objective functions for the cost, the carbon emission, and the weight are solved with a non-dominated sorting genetic algorithm II (NSGA-II) to obtain a Pareto solution set for a candidate resilient product design scheme.

11. The resilience-oriented product design method for the high-impact disturbance absorption, adaptation, and autonomous recovery according to claim 2, further comprising:
S6: constructing objective functions and constraints for a cost, a carbon emission, and a weight in the resilient product design scheme, and solving the objective functions to obtain a candidate resilient design scheme.

12. The resilience-oriented product design method for the high-impact disturbance absorption, adaptation, and autonomous recovery according to claim 3, further comprising:
S6: constructing objective functions and constraints for a cost, a carbon emission, and a weight in the resilient product design scheme, and solving the objective functions to obtain a candidate resilient design scheme.

13. The resilience-oriented product design method for the high-impact disturbance absorption, adaptation, and autonomous recovery according to claim 4, further comprising:
S6: constructing objective functions and constraints for a cost, a carbon emission, and a weight in the resilient product design scheme, and solving the objective functions to obtain a candidate resilient design scheme.

14. The resilience-oriented product design method for the high-impact disturbance absorption, adaptation, and autonomous recovery according to claim 5, further comprising:
S6: constructing objective functions and constraints for a cost, a carbon emission, and a weight in the resilient product design scheme, and solving the objective functions to obtain a candidate resilient design scheme.

15. The resilience-oriented product design method for the high-impact disturbance absorption, adaptation, and autonomous recovery according to claim 6, further comprising:
S6: constructing objective functions and constraints for a cost, a carbon emission, and a weight in the resilient product design scheme, and solving the objective functions to obtain a candidate resilient design scheme.

16. The resilience-oriented product design method for the high-impact disturbance absorption, adaptation, and autonomous recovery according to claim 7, further comprising:
S6: constructing objective functions and constraints for a cost, a carbon emission, and a weight in the resilient product design scheme, and solving the objective functions to obtain a candidate resilient design scheme.

17. The resilience-oriented product design method for the high-impact disturbance absorption, adaptation, and autonomous recovery according to claim 11, wherein the objective functions for the cost, the carbon emission, and the weight in the resilient product design scheme are constructed as follows:
$$\{ \begin{matrix}min C = {\sum }_{k = 1}^{K} {\sum }_{l = 1}^{L} {ε}_{kl} ( cos {t}_{kl}^{Raw} + cos {t}_{kl}^{Design} + cos {t}_{kl}^{Manufacturing} + cos {t}_{kl}^{Service} ) \\ min E = {\sum }_{k = 1}^{K} {\sum }_{l = 1}^{L} {ε}_{kl} ( {CFP}_{kl}^{Raw} + {CFP}_{kl}^{Del} + {CFP}_{kl}^{Manufacturing} + \\ {CFP}_{kl}^{Use} + {CFP}_{kl}^{Eol} ) \\ min W = {\sum }_{k = 1}^{K} {\sum }_{l = 1}^{L} {ε}_{kl} ( {V}_{kl} * {ρ}_{kl} )\end{matrix} ,$$
wherein εₖₗ represents a weight of an lth structure of a kth function;
$$cos {t}_{kl}^{Raw}$$
represents a raw material cost of the lth structure of the kth function;
$$cos {t}_{kl}^{Design}$$
represents a design cost of the lth structure of the kth function;
$$cos {t}_{kl}^{Manufacturing}$$
represents a manufacturing cost of the lth structure of the kth function;
$$cos {t}_{kl}^{Service}$$
represents a service cost of the lth structure of the kth function;
$${CFP}_{kl}^{Raw}$$
represents a carbon emission generated in acquisition of raw material of the lth structure of the kth function;
$${CFP}_{kl}^{Del}$$
represents a carbon emission generated in distribution of the lth structure of the kth function;
$${CFP}_{kl}^{Manufacturing}$$
represents a carbon emission generated in manufacturing of the lth structure of the kth function;
$${CFP}_{kl}^{Use}$$
represents a carbon emission generated in use of the lth structure of the kth function;
$${CFP}_{kl}^{Eol}$$
represents a carbon emission generated at an end of life (EOL) of the lth structure of the kth function; Vₖₗ represents a volume of the lth structure of the kth function; ρₖₗ represents a density of the lth structure of the kth function; and K and L respectively represent a number of functions and a number of structures under corresponding functions; and
the constraints are as follows:
$$\{ \begin{matrix}C * ( 1 + α ) \leq {C}_{m ax} \\ E \leq {E}_{m ax} \\ W \leq {W}_{m ax} \\ {\sum }_{k = 1}^{K} {ε}_{kl} = 1 , for 1 = 1 , 2 , 3 , … L\end{matrix} ,$$
wherein Cₘₐₓ, Eₘₐₓ and Wₘₐₓ respectively represent a maximum cost, a maximum carbon emission, and a maximum weight; and a represents an extra cost coefficient.

18. The resilience-oriented product design method for the high-impact disturbance absorption, adaptation, and autonomous recovery according to claim 12, wherein the objective functions for the cost, the carbon emission, and the weight in the resilient product design scheme are constructed as follows:
$$\{ \begin{matrix}min C = {\sum }_{k = 1}^{K} {\sum }_{l = 1}^{L} {ε}_{kl} ( cos {t}_{kl}^{Raw} + cos {t}_{kl}^{Design} + cos {t}_{kl}^{Manufacturing} + cos {t}_{kl}^{Service} ) \\ min E = {\sum }_{k = 1}^{K} {\sum }_{l = 1}^{L} {ε}_{kl} ( {CFP}_{kl}^{Raw} + {CFP}_{kl}^{Del} + {CFP}_{kl}^{Manufacturing} + \\ {CFP}_{kl}^{Use} + {CFP}_{kl}^{Eol} ) \\ min W = {\sum }_{k = 1}^{K} {\sum }_{l = 1}^{L} {ε}_{kl} ( {V}_{kl} * {ρ}_{kl} )\end{matrix} ,$$
wherein εₖₗ represents a weight of an lth structure of a kth function;
$$cos {t}_{kl}^{Raw}$$
represents a raw material cost of the lth structure of the kth function;
$$cos {t}_{kl}^{Design}$$
represents a design cost of the lth structure of the kth function;
$$cos {t}_{kl}^{Manufacturing}$$
represents a manufacturing cost of the lth structure of the kth function;
$$cos {t}_{kl}^{Service}$$
represents a service cost of the lth structure of the kth function;
$${CFP}_{kl}^{Raw}$$
represents a carbon emission generated in acquisition of raw material of the lth structure of the kth function;
$${CFP}_{kl}^{Del}$$
represents a carbon emission generated in distribution of the lth structure of the kth function;
$${CFP}_{kl}^{Manufacturing}$$
represents a carbon emission generated in manufacturing of the lth structure of the kth function;
$${CFP}_{kl}^{Use}$$
represents a carbon emission generated in use of the lth structure of the kth function;
$${CFP}_{kl}^{Eol}$$
represents a carbon emission generated at an end of life (EOL) of the lth structure of the kth function; Vₖₗ represents a volume of the lth structure of the kth function; ρₖₗ represents a density of the lth structure of the kth function; and K and L respectively represent a number of functions and a number of structures under corresponding functions; and
the constraints are as follows:
$$\{ \begin{matrix}C * ( 1 + α ) \leq {C}_{max} \\ E \leq {E}_{max} \\ W \leq {W}_{max} \\ {\sum }_{k = 1}^{K} {ε}_{kl} = 1 , for l = 1 , 2 , 3 , … L\end{matrix} ,$$
wherein Cₘₐₓ, Eₘₐₓ and Wₘₐₓ respectively represent a maximum cost, a maximum carbon emission, and a maximum weight; and a represents an extra cost coefficient.

19. The resilience-oriented product design method for the high-impact disturbance absorption, adaptation, and autonomous recovery according to claim 13, wherein the objective functions for the cost, the carbon emission, and the weight in the resilient product design scheme are constructed as follows:
$$\{ \begin{matrix}min C = {\sum }_{k = 1}^{K} {\sum }_{l = 1}^{L} {ε}_{kl} ( cos {t}_{kl}^{Raw} + cos {t}_{kl}^{Design} + cos {t}_{kl}^{Manufacturing} + cos {t}_{kl}^{Service} ) \\ min E = {\sum }_{k = 1}^{K} {\sum }_{l = 1}^{L} {ε}_{kl} ( {CFP}_{kl}^{Raw} + {CFP}_{kl}^{Del} + {CFP}_{kl}^{Manufacturing} + {CFP}_{kl}^{Use} + {CFP}_{kl}^{Eol} ) \\ min W = {\sum }_{k = 1}^{K} {\sum }_{l = 1}^{L} {E}_{kl} ( {V}_{kl} * {ρ}_{kl} )\end{matrix} ,$$
wherein εₖₗ represents a weight of an lth structure of a kth function;
$$cos {t}_{kl}^{Raw}$$
represents a raw material cost of the lth structure of the kth function;
$$cos {t}_{kl}^{Design}$$
represents a design cost of the lth structure of the kth function;
$$cos {t}_{kl}^{Manufacturing}$$
represents a manufacturing cost of the lth structure of the kth function;
$$cos {t}_{kl}^{Service}$$
represents a service cost of the lth structure of the kth function;
$${CFP}_{kl}^{Raw}$$
represents a carbon emission generated in acquisition of raw material of the lth structure of the kth function;
$${CFP}_{kl}^{Del}$$
represents a carbon emission generated in distribution of the lth structure of the kth function;
$${CFP}_{kl}^{Manufacturing}$$
represents a carbon emission generated in manufacturing of the lth structure of the kth function;
$${CFP}_{kl}^{Use}$$
se represents a carbon emission generated in use of the lth structure of the kth function;
$${CFP}_{kl}^{Eol}$$
represents a carbon emission generated at an end of life (EOL) of the lth structure of the kth function; Vₖₗ represents a volume of the lth structure of the kth function; ρₖₗ represents a density of the lth structure of the kth function; and K and L respectively represent a number of functions and a number of structures under corresponding functions; and
the constraints are as follows:
$$\{ \begin{matrix}C * ( 1 + α ) \leq {C}_{m ax} \\ E \leq {E}_{m ax} \\ W \leq {W}_{m ax} \\ {\sum }_{k = 1}^{K} {ε}_{kl} = 1 , for 1 = 1 , 2 , 3 , … L\end{matrix} ,$$
wherein Cₘₐₓ, Eₘₐₓ and Wₘₐₓ respectively represent a maximum cost, a maximum carbon emission, and a maximum weight; and a represents an extra cost coefficient.

20. The resilience-oriented product design method for the high-impact disturbance absorption, adaptation, and autonomous recovery according to claim 14, wherein the objective functions for the cost, the carbon emission, and the weight in the resilient product design scheme are constructed as follows:
$$\{ \begin{matrix}min C = {\sum }_{k = 1}^{K} {\sum }_{l = 1}^{L} {ε}_{kl} ( cos {t}_{kl}^{Raw} + cos {t}_{kl}^{Design} + cos {t}_{kl}^{Manufacturing} + cos {t}_{kl}^{Service} ) \\ min E = {\sum }_{k = 1}^{K} {\sum }_{l = 1}^{L} {ε}_{kl} ( {CFP}_{kl}^{Raw} + {CFP}_{kl}^{Del} + {CFP}_{kl}^{Manufacturing} + \\ {CFP}_{kl}^{Use} + {CFP}_{kl}^{Eol} ) \\ min W = {\sum }_{k = 1}^{K} {\sum }_{l = 1}^{L} {ε}_{kl} ( {V}_{kl} * {ρ}_{kl} )\end{matrix} ,$$
wherein εₖₗ represents a weight of an lth structure of a kth function;
$$cos {t}_{kl}^{Raw}$$
represents a raw material cost of the h structure of the kth function;
$$cos {t}_{kl}^{Design}$$
represents a design cost of the lth structure of the kth function;
$$cos {t}_{kl}^{Manufacturing}$$
represents a manufacturing cost of the lth structure of the kth function;
$$cos {t}_{kl}^{Service}$$
represents a service cost of the lth structure of the kth function;
$${CFP}_{kl}^{Raw}$$
represents a carbon emission generated in acquisition of raw material of the lth structure of the kth function;
$${CFP}_{kl}^{Del}$$
represents a carbon emission generated in distribution of the lth structure of the kth function;
$${CFP}_{kl}^{Manufacturing}$$
manufacturing represents a carbon emission generated in manufacturing of the lth structure of the kth function;
$${CFP}_{kl}^{Use}$$
represents a carbon emission generated in use of the lth structure of the kth function;
$${CFP}_{kl}^{Eol}$$
represents a carbon emission generated at an end of life (EOL) of the lth structure of the kth function; Vₖₗ represents a volume of the lth structure of the kth function; ρₖₗ represents a density of the lth structure of the kth function; and K and L respectively represent a number of functions and a number of structures under corresponding functions; and
the constraints are as follows:
$$\{ \begin{matrix}C * ( 1 + α ) \leq {C}_{m ax} \\ E \leq {E}_{m ax} \\ W \leq {W}_{m ax} \\ {\sum }_{k = 1}^{K} {ε}_{kl} = 1 , for 1 = 1 , 2 , 3 , … L\end{matrix} ,$$
wherein Cₘₐₓ, Eₘₐₓ and Wₘₐₓ respectively represent a maximum cost, a maximum carbon emission, and a maximum weight; and a represents an extra cost coefficient.
